(19) United States
(12) Patent Application Publication
(10) Pub. No.: US 2007/0282704 A1
(43) Pub. Date: Dec. 6, 2007

(54) COMPUTERIZED PROCESSING USING HANDHELD APPARATUS

(75) Inventors: Rachel Elizabeth DeMaster, Falcon Heights, MN (US); Michael John Pickett, Eau Claire, WI (US); Jeffrey Dean Donnelly, Woodbury, MN (US)

Correspondence Address: SCHWEGMAN, LUNDBERG & WOESSNER, P.A., P.O. BOX 2938, MINNEAPOLIS, MN, 55402, US

(73) Assignee: G&K SERVICES, INC, MINNETONKA, MN (US)

(21) Appl. No.: 11/759,133

(22) Filed: Jun. 6, 2007

Related U.S. Application Data
(60) Provisional application No. 60/804,063, filed on Jun. 6, 2006.

(51) Int. Cl. G06Q 30/00

(52) U.S. Cl. 705/26

(57) ABSTRACT

A route service system and process for industrial applications includes, according to one example embodiment, a computer system having remote hand-held units, and begins with a preview route function which is, according to one example embodiment, completed one to three (3) days prior to service. The route service function summarizes items for a route service representative (RSR) that they may need to be aware of for servicing the route. A service route/supplied entity function leads the RSR through the steps needed to service each supplied entity on their route from start to finish. A check-in/approve route function gives visibility to management at the supply entity following a route's completion to assure proper business controls. According to one example embodiment, following the RSRs completion of a route, visibility of changes on the route are available to management and must be approved.

### CROSS REFERENCE TO RELATED APPLICATIONS

This application claims benefit of priority to Provisional Application Ser. No. 60/804,063, filed on Jun. 6, 2006 the entire disclosure of which is incorporated herein by reference.

### TECHNICAL FIELD

The subject matter relates generally to the field of computerized processing, and more particularly to computerized processing used to service a route.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2006, G&K Services, Inc. All Rights Reserved.

### BACKGROUND

Many industrial processes including most volume manufacturing processes have been heavily automated over the last one-hundred years. In more recent times, computers have been used extensively to control automated processes. Computerization, however, has been applied less pervasively in decentralized industrial processes, where the operations are performed, for example, in the field and away from a facility such as a factory or manufacturing plant. One industrial process involves the distribution and cleaning of uniforms used for example by workers in an industrial plant, or working in various service industries, such as hospitals or restaurants. This process may be labor intensive in some respects as it often requires a vehicle 120 and route service representative to drop-off and pick-up of uniforms at the facilities where the uniforms are used. In many cases there is still a considerable volume of paperwork associated with these processes. Computerization of this industrial process thus presents the opportunity to increase efficiency and increase productivity.

### SUMMARY

According to one example embodiment, there is provided system and method to present a summary of at least one activity for the supplied entity account wherein the activity is selected from the group: a review of orders, returns, other changes, service calls and sampling activity.

### BRIEF DESCRIPTION OF THE DRAWING

FIG. 1 illustrates a system according to one example embodiment of the inventive subject matter disclosed herein;

FIGS. 2A and 2B illustrates a computer system according to one example embodiment of the inventive subject matter disclosed herein;

FIG. 3 illustrates a database of information according to one example embodiment of the inventive subject matter disclosed herein;

FIG. 4A illustrates a functionality diagram according to one example embodiment of the inventive subject matter disclosed herein;

FIG. 4B illustrates a functionality diagram according to one example embodiment of the inventive subject matter disclosed herein;

FIG. 4C illustrates a functionality diagram according to one example embodiment of the inventive subject matter disclosed herein;

FIG. 4D illustrates a functionality diagram according to one example embodiment of the inventive subject matter disclosed herein;

FIG. 5 illustrates a flow chart of an example embodiment of a method according to the inventive subject matter disclosed herein;

FIG. 6A illustrates a flow chart of an example embodiment of a method according to the inventive subject matter disclosed herein;

FIG. 6B illustrates a flow chart of an example embodiment of a method according to the inventive subject matter disclosed herein;

FIG. 7 illustrates a flow chart of a further method according to one example embodiment of the inventive subject matter disclosed herein;

FIGS. 8 and 9 illustrate reports in displayed or printed formats according to one example embodiment of the inventive subject matter disclosed herein; and

FIGS. 10, 11A, and 11B illustrate additional example embodiments according to the inventive subject matter disclosed herein.

### DETAILED DESCRIPTION

In the following detailed description, reference is made to the accompanying drawings that form a part hereof, and in which are shown, by way of illustration, specific embodiments in which the inventive subject matter can be practiced. It is understood that other embodiments may be utilized and structural changes may be made without departing from the scope of the inventive subject matter. The leading digit(s) of reference numbers appearing in the Figures generally corresponds to the Figure number in which that component is first introduced, such that the same reference number is used throughout to refer to an identical component which appears in multiple Figures. Signals and connections may be referred to by the same reference number or label, and the actual meaning will be clear from its use in the context of the description.

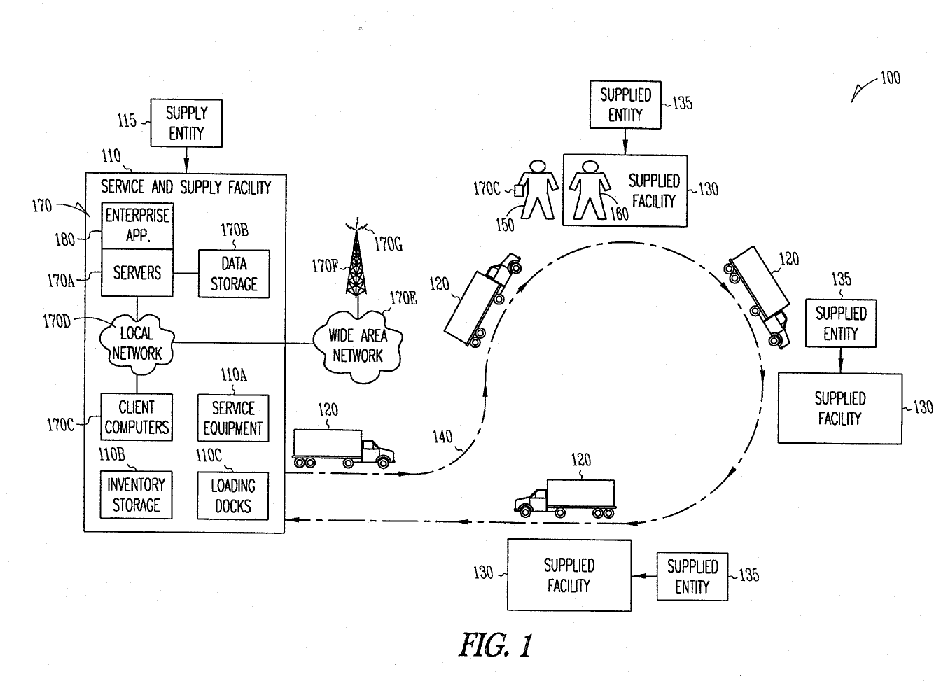

According to one embodiment of the inventive subject matter, there is provided a system and method for computerization and automation of the route service functions for an industrial supply process. According to one example embodiment, as illustrated in FIG. 1, the industrial supply system 100 includes one or more service and supply facilities 110 including service equipment 110a such as cleaning equipment to provide cleaning services, inventory storage areas 110b, and loading docks 110c. System 100 further includes a plurality of route service vehicles 120 that may be any form of vehicle but more typically a truck capable of transporting industrial supplies and other items to and from supplied facilities 130. Supplied facilities 130 may include, without limitation, manufacturing, industrial, educational, health-care, restaurant or other facilities. Supply facilities 110 may be owned or operated by Supply Entities 115. Supplied facilities 130 may be owned or operated by Supplied Entities 135.

According to one example embodiment, a route service vehicle 120 is used by a Route Service Representatives (RSRs) 150 to work with Facility Representatives (FRs) 160 at supplied facilities 130 on a route 140 to provide services and products used in the supplied facilities 130. According to one example embodiment, the services and products include cleaning services for uniforms, mats, linens, and other items used in, and further, in one embodiment, selling or leasing such items or other items to such supplied entities. The RSRs 150, among other things, deliver new and cleaned industrial supplies, pick up soiled supplies for cleaning, such as uniforms or linens used in the facility or by facility workers, add/delete/change supplies ordered or used by the facility, and provide an invoice following service. The invoice may, in one example embodiment, be presented to the supplied entity 135 through its FR 160. According to one example embodiment, RSRs 150 are encouraged to use standard communication steps between the RSR 150 and the FRs 160.

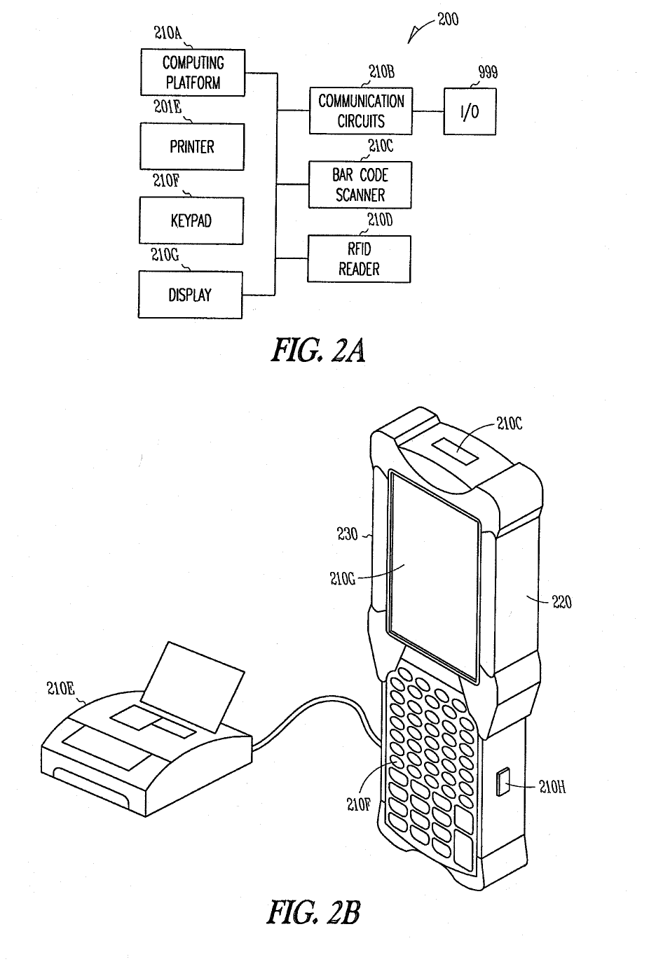

Supply system 100 further utilizes, in one example embodiment, a computer system 170. Computer system 170 may include one or more servers 170a and data storage units 170b connected to client computers 170c (or in other example embodiments, other terminal devices) through a network 170d. Servers 170a and data storage units 170b support an enterprise management application 180 that stores data that may be used in order to automate the process of servicing and supplying the supplied facilities by the supply entity 115 that may own or operate the supply facility 110. One or more of client computers 170c may be implemented as a hand-held unit shown in more detail as unit 200 in FIG. 2. Such units may communicate with servers 170A through a wide area network 170E and a wireless transmission facility 170F, which sends and receives wireless signals 170G. At least one of the client computers 170c is used as a route manager work station. In addition, system 100 includes at least one docking station (not shown) that may make a wireless connection to a hand held unit 200 or be connected by a hard wired cradle-type connection.

Referring now to FIGS. 2A and 2B, hand held unit 200 may include, in one example embodiment, electronic components 210 that include a computing platform 210a including hardware and software, communication circuits 210b to provide wired or wireless network communication of the hand held unit 200 with the computer system 170, a bar code scanner unit 210c, and/or a RFID reader 210d, a printer unit 210e (a separate portable printer device available from O'Neil Product Development, Inc., of Irvine, Calif.) and a keypad 210f. Elements 210a to 210f are all mounted in or on or integrated with a housing 220. Housing 220 and one or more of the components 210a to 210f may be ruggedized so as to allow hand held unit 200 to be used inside or outside in inclement weather, and to be able to handle the type of wear and tear typically encountered in a field application. According to one example embodiment, the hand held unit 200 may be obtained from Symbol Technologies, Inc., of Holtsville, N.Y. According to another example embodiment, housing 220 has a handle portion 230 which is, in one example embodiment, sized so it allows a user to grip and hold the unit 200 in one hand while the other hand is used for other purposes, for example to key in commands or data into the unit 200. In addition, hand held unit 200 further includes, in one example embodiment, a docking station connector (not shown) that may allow it to be placed in a docking station cradle to upload and download information from the servers 170a.

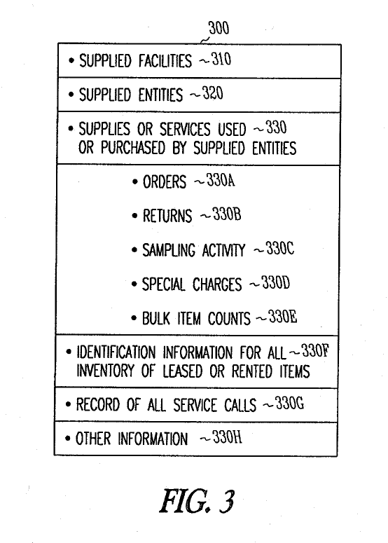

Referring to FIG. 3, information 300 maintained by the enterprise management application 180 may include, without limitation, one or more of the following categories of information: information 310 identifying supplied facilities 130 or information 320 identifying supplied entities 135, information 330 regarding supplies or services used or purchased by supplied entities 135, such as orders 330a, returns 330b, sampling activity 330c, special charges 330d or bulk item counts 330e. Also included in information 300 may be identification information 330f for all inventory of leased or rented items, or other such items, such that a bar code or RFID tag, or printed serial number, may be used on the item to either identify it by category or uniquely. Information 300 may further include a record of all service 330g calls made by service entities 135, such that the RSR's 150 may review such information prior to a site visit at the supplied facility 130. Information 300 may also include, in another example embodiment, any further information 330h required or advantageous to maintain to support the computerized functions described below with respect to the remaining figures.

According to one example embodiment, sampling activity includes providing a supplied entity 135 with product or service samples that the supplied entity 135 is allowed to use for free or at a discounted rate. Such samples may be routinely stocked in a vehicle 120, or be specially brought to a supplied entity 135 based on a need or possible need of the supplied entity 135. This sampling activity provides the supplied entity 135 with an opportunity to learn about new products or services, usually provided by the supplying entity 115 for a fee. As described above and further below, such sampling activity is tracked and coordinated, and converted from a sampling activity to a sale, using the system 100.

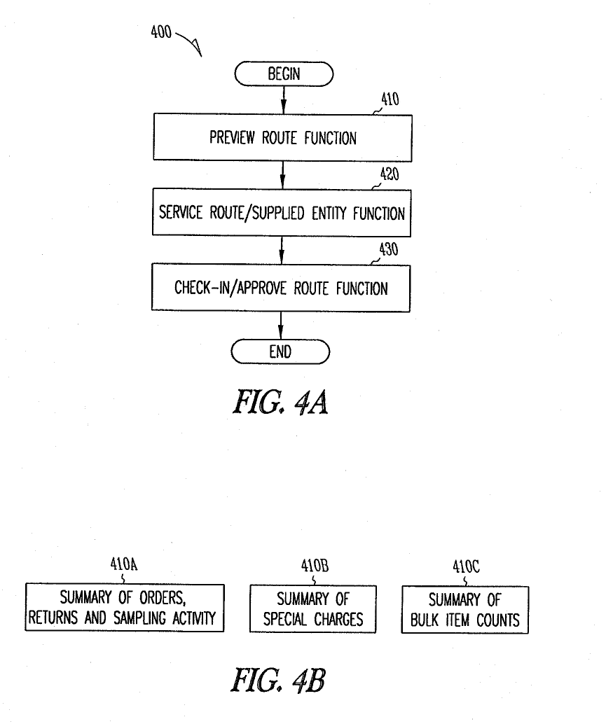

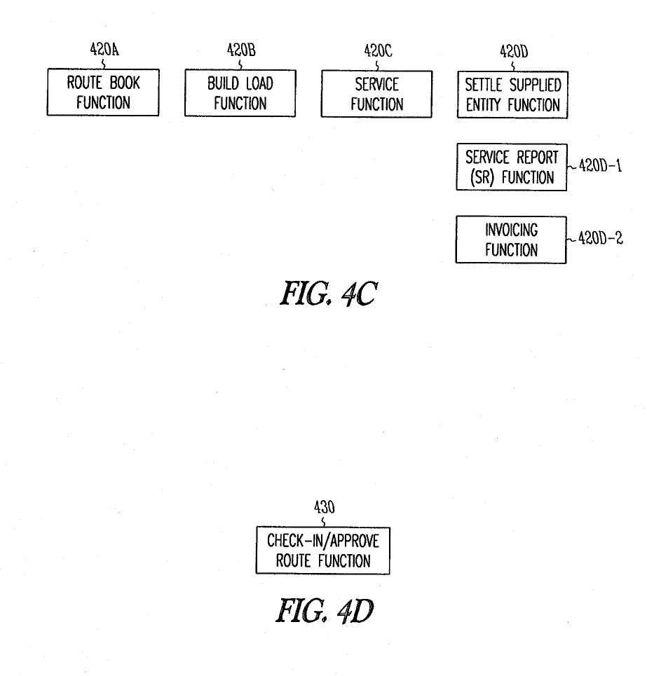

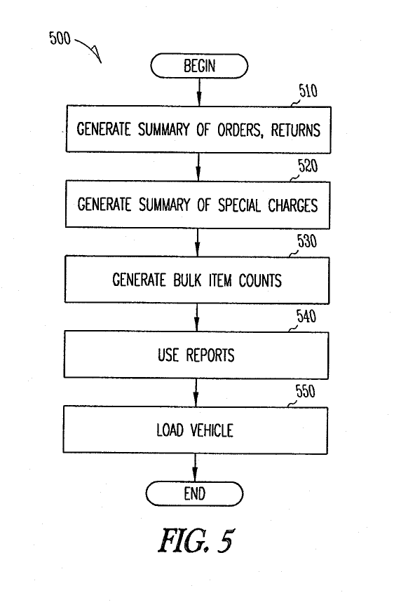

Referring now to FIG. 4A, there is illustrated an overview of a route service process 400 according to one example embodiment. The process 400 begins with the Preview Route function 410 which is, according to one example embodiment, completed one to three (3) days prior to service. The purpose of function 410 is to summarize items for the RSR 150 that they may need to be aware of or cause them to take action. The Service Route/Supplied entity function 420 leads the RSR 150 through the steps needed to service each supplied entity 135 on their route from start to finish. The Check-in/Approve Route function 430 gives visibility to management at the supply entity 115 following a route's completion to assure proper business controls. According to one example embodiment, following the RSRs 150 completion of a route, visibility of changes on the route are available to management and must be approved.

Within each of these functions, there are sub-functions that have been created to assist in servicing the supplied entity. Referring now to FIG. 4B, the Preview Route functions 410 are described in more detail. Preview Route functions 410 include:
a) A summary 410a of Orders, Returns and Sampling activity for a date selected in the future draws the RSR's 150 attention to items they may need to be aware of or cause them to take action.
b) A summary 410b of Special Charges for date selected in the future draws the RSR's 150 attention to charges that are outside of the norm for a supplied entity. This makes the RSR 150 aware of potential disputes or charges needing to be clarified for the supplied entity.
c) A summary 410c of Bulk item counts that out of the ordinary are identified, alerting the RSR 150 to potential mistakes. This is determined through calculations using historical supplied entity turn-in quantities and is known as Soil Reasonability. This gives the RSR 150 the ability to correct the items prior to loading the vehicle 120 and servicing the supplied entity.

According to one example embodiment, Soil Reasonability refers to a measure or gauge of what quantity of soiled garments or other items are typically picked up from a particular supplied entity 135 or supplied facility 130, on a particular day or based on other variables. If the number of items is unexpectedly high, then the RSR 150 may be alerted to check and make sure that there has not been a mistake, such as clean garments being inadvertently sent in for cleaning, or to see if the amount of soiling experienced by the supplied facility 130 is out of the ordinary, and therefore should be called to the attention of a facility representative 160.

Referring to FIG. 4C, the Service Route functions 420 include the following:
a) A Route Book function 420a provides, in one example embodiment, textual instructions for driving directions, service directions, and other notes pertinent to the correct execution of service to a supplied entity. This enables consistency of service if route staff turns-over, or if a replacement driver is needed.
b) A Build Load function 420b is presented to the RSR 150 to provide details of the load they are to prepare prior to entering the supplied entity site, thus improving the accuracy of delivery and limits the trips the RSR 150 needs to take to the vehicle 120.
c) A Service function 420c is presented to the RSR 150 while inside the supplied entity's site. It gives the RSR 150 the ability to do the following:
   1) Add/Change products and orders with the appropriate pricing, which is based on many variables and restrictions, such as frequency, contract prices, local prices, and corporate prices.
   2) Process Returns that are due, which generates appropriate credits and charges when invoicing. This is accomplished by scanning unique barcodes on the returned merchandise that are provided by a garment tracking system.
   3) View/Edit Supplied entity Information such as preferences, contact information, and status.
d) A Settle Supplied entity function 420d leads the RSR 150 through the appropriate steps needed to finish the visit with the supplied entity, ensuring consistency and needed business controls. The Settle Supplied entity function 420d includes the following functions:
   1) A Service Report (SR) function 420d-1 presents the RSR 150 and the Supplied entity a summary of activity at their account. This ensures the standard execution of critical communication steps such as a review of Orders, Returns, Other Changes, Service Calls and Sampling Activity. This can also be printed to leave with the supplied entity.
   2) An Invoicing function 420d-2 automatically calculates based on any changes made to the account that week. Each line item can be viewed and adjusted. The system ensures the supplied entity signature is captured unless not required (preference maintained in the system). This can also be printed in summary or detailed format to leave with the supplied entity.

According to one example embodiment, the SR function 420d-1 produces, as referred to above, enables the supply entity 115 to inform the supplied entity 135 of all of the value being delivered for the supplied entity 135, outside of and as a separate process to the invoicing process. A SR may thus be a summary or review of all activity at the supplied entity 135's account, whether or not such activity is an event, product or service that can be invoiced to the supplied entity 135. Such a summary or review may be of Orders, Returns, Other Changes, Service Calls and Sampling Activity, only some of which may involve invoicing the supplied entity 135. This summary or review can be gone over using the display on the handheld unit 170C, reported to the supplied entity 135 verbally from the handheld 170C display, or can be printed to leave with the supplied entity 135.

Referring now to FIG. 4D, the Check-in/Approve Route functions 430 include the following:
a) Visibility to management personnel of all Invoice Adjustments to ensure proper business controls.
b) Visibility to management personnel of all Maintenance (Orders, Changes, and Returns) to ensure proper business controls.
c) Visibility to management personnel of all Sampling activity to provide a coaching opportunity for management to discuss this common sales technique on the route.

Thus, according to one example embodiment, the system 100 automates the processes 400 and implements a number of the processes performed in the field using the portable handheld unit 200. The system 100 may be centered on the RSR's 150 process of servicing the serviced entities 135 to create an efficient, electronic method of completing the routine tasks of delivery, orders, changes, and invoicing. The system 100 may also systematizes important communication steps that help to build the relationship between the RSR 150 and the serviced entity 135.

Referring now to FIG. 5, there is illustrated a flow chart of a preview route process 500 according to one example embodiment of the inventive subject matter. A RSR 150 accesses system 180 through one of client computers 170c and using functions 420 generates 510 a summary of Orders, Returns and Sampling activity for a date selected in the future. The system 180 further generates 520 a summary of Special Charges for date selected in the future draws the RSR's 150 attention to charges that are outside of the norm for a supplied entity. This makes the RSR 150 aware of potential disputes or charges needing to be clarified for the supplied entity. In addition, RSR 150 uses the functions 420 to generate 530 a summary of Bulk item counts that out of the ordinary are identified, alerting the RSR 150 to potential mistakes. This is determined through calculations using historical supplied entity turn-in quantities and is known as Soil Reasonability. The RSR 150 may use 540 the reports and summaries to identify problems or anomalies in the information, and then correct the items prior to loading 550 the vehicle 120 and servicing the supplied entity.

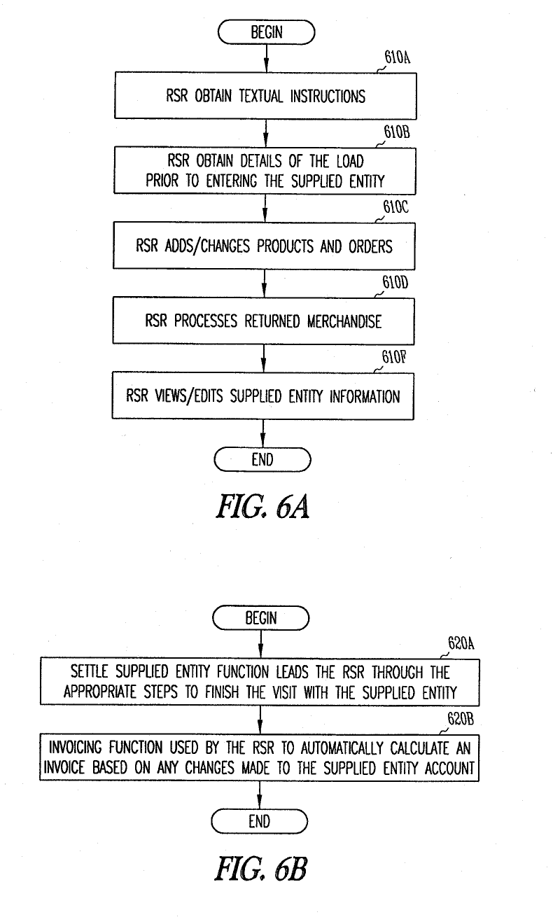

Referring now to FIG. 6A, there is illustrated a flow chart of a service route process according to one example embodiment of the inventive subject matter, using service route functions 420. A RSR 150 may use 610a, in one example embodiment, the Route Book function 420a to obtain textual instructions for driving directions, service directions, and other notes pertinent to the correct execution of service to a supplied entity. When at a supplied entity site, the RSR 150 may use 610b the Build Load function 420b to obtain details of the load they are to prepare prior to entering the supplied entity 130 site, thus improving the accuracy of delivery and limits the trips the RSR 150 needs to take to the vehicle 120. While inside the supplied facility 130, the RSR 150 may use 610c the Service function 420c to a) Add/Change products and orders with the appropriate pricing, which is based on many variables and restrictions, such as frequency, contract prices, local prices, and corporate prices; b) process 610d, for example by scanning unique barcodes on the returned merchandise that are provided by a garment tracking system, Returns that are due, which generates appropriate credits and charges when invoicing; or c) View/Edit 610e Supplied entity Information such as preferences, contact information, and status.

Referring now to FIG. 6B, there is further illustrated the service route process 600 according to one example embodiment of the inventive subject matter. To settle an account, the RSR 150 may use 620a the Settle Supplied entity function 420d to lead the RSR 150 through the appropriate steps needed to finish the visit with the supplied entity, ensuring consistency and needed business controls. The Settle Supplied entity function 420d leads the RSR 150 through the following process. The RSR 150 uses, during the visit to the service entity 135's facility 130, the Value on Site (SR) function 420d-1 to obtain a summary of activity of the serviced entities 135 account. The SR function 420d-1 ensures the standard execution of critical communication steps by presenting information, on the display 210g of the hand-held 200, or by printing the information, a review of Orders, Changes requested, for example changes requested that day, Lost and Damaged items, such as uniforms, linens or supplies provided to the entity 135, Returns, Other Changes, Service Calls and Sampling Activity. This can also be printed to leave with the supplied entity. The Invoicing function 420d-2 may be used 620b by the RSR 150 to automatically calculate an invoice based on any changes made to the supplied entity 135's account that week.

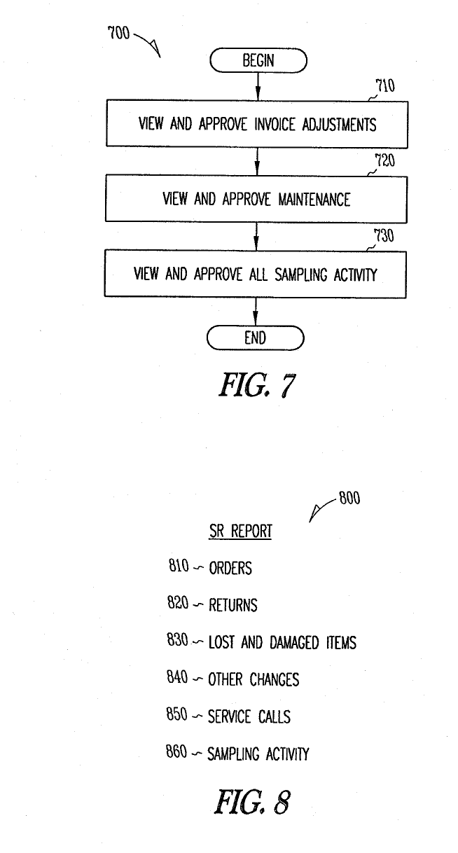

Referring now to FIG. 7, there is illustrated a flow chart of a Check-in/Approve Route process 700 according to one example embodiment of the inventive subject matter. In process 700, the managing personnel for the RSR 150 may use the Check-in/Approve Route functions 430 to a) view and approve 710 all Invoice Adjustments to ensure proper business controls; b) view and approve 720 all Maintenance (Orders, Changes, and Returns) to ensure proper business controls; and c) view and approve 730 all Sampling activity to provide a coaching opportunity for management to discuss this common sales technique on the route. According to one example embodiment, a RSR 150 may be checked in remotely. A RSR 150 may, for example, complete a route at a first location remote from second location, and upload information from the hand-held unit 200 to the servers 170a. A route manager for the RSR 150 located at the second location, for example another city or suburb, may use a route manager work station at the second location to review the activity of the RSR 150 using the process 700, and check in the RSR 150.

Referring to FIG. 8, there is illustrated one example embodiment of a SR report 800 generated by the SR function 420d-1. As indicated, the SR report may include indications of Orders 810, Returns 820, Lost and Damaged items 830, Other Changes 840, Service Calls 850 and Sampling Activity 860.

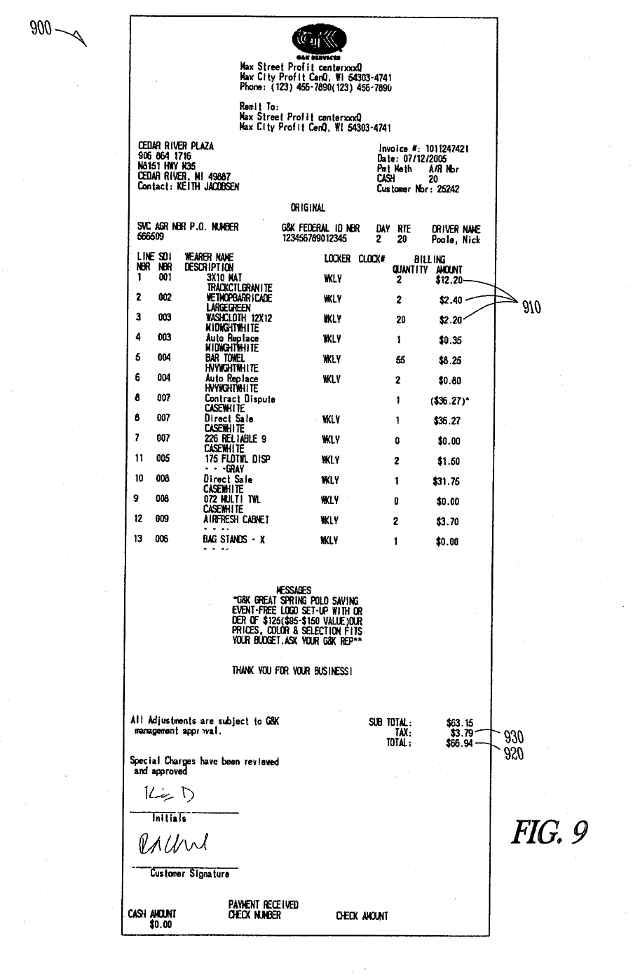

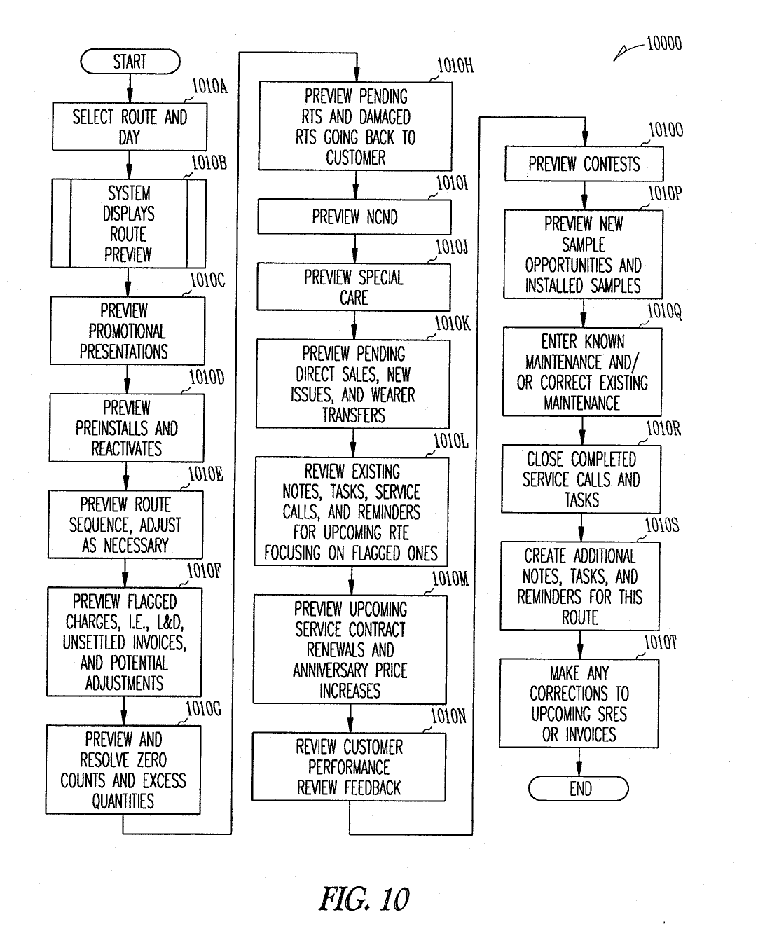

Referring to FIG. 9, there is illustrated an example embodiment of an invoice 900 generated by invoicing function 420d-2. Each line item 910 of the invoice can be viewed and adjusted 620c. Line items 910 are totaled and shown as total 920, for example including a tax 930. The process 600 also ensures the supplied entity signature is captured 620d unless not required (preference maintained in the system). This can also be printed in summary or detailed format to leave with the supplied entity.

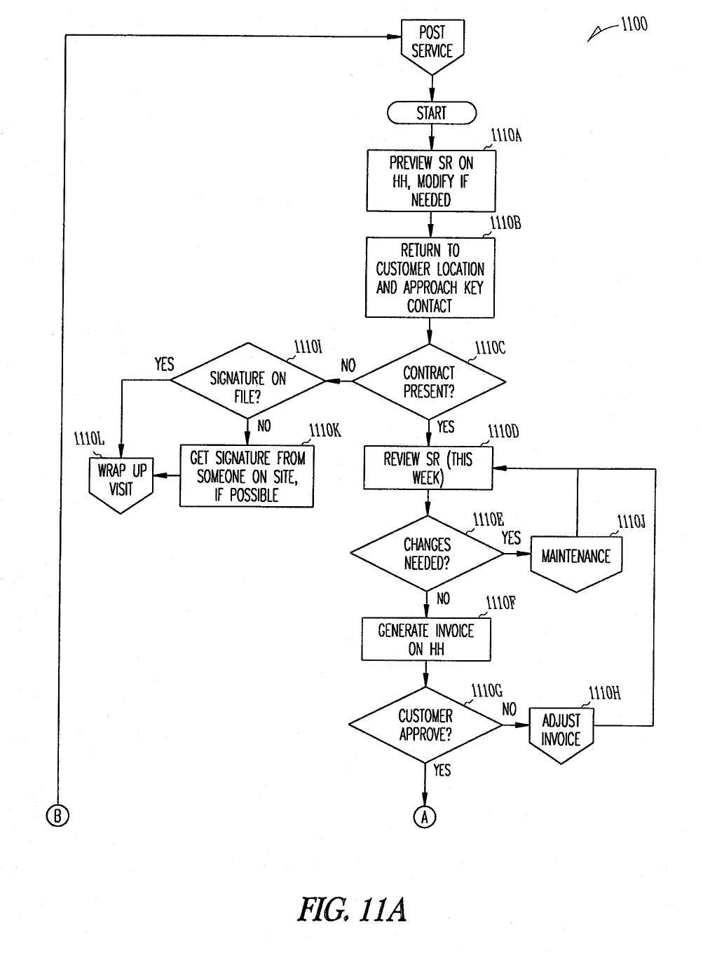

Referring now to FIG. 10, there is illustrated an example embodiment 1000 of a process for previewing a route by an RSR 150 according to still another example embodiment, using the review route function. A route and day is selected 1010A, and the system displays the route preview 1010B, including a preview of promotional presentations 1010C, a preview of pre-installs and reactivates 1010D, a preview of route sequence 1010E, which can be adjusted as necessary. Embodiment 1000 includes a preview of various data stored in the system 100, for example as may be downloaded into the handheld 170C. Such data may include flagged charges 1010F, i.e., L&D, unsettled invoices, and potential adjustments, a preview of and resolve zero counts and excess quantities 1010G, a preview of pending RTS and damaged RTS going back to customer 1010H, a preview of accounts with no check, no delivery (NCND) status 1010I, a preview of special care 1010J, a preview of pending direct sales, new issues, and wearer transfers 1010K, a review of existing notes, tasks, service calls, and reminders for upcoming route focusing on flagged ones 1010L, for example ones that require service calls within 24 hours, a preview of upcoming service contract renewals and anniversary price increases 1010M, a review customer performance review feedback 1010N, a preview of contests 1010O, a preview of new sample opportunities and installed samples 1010P, the entering of known maintenance and/or correct existing maintenance 1010Q, closing completed service calls and tasks 1010R, the creation of additional notes, tasks, and reminders for the route 1010S, and the performance of any corrections to upcoming SR's or invoices 1010T.

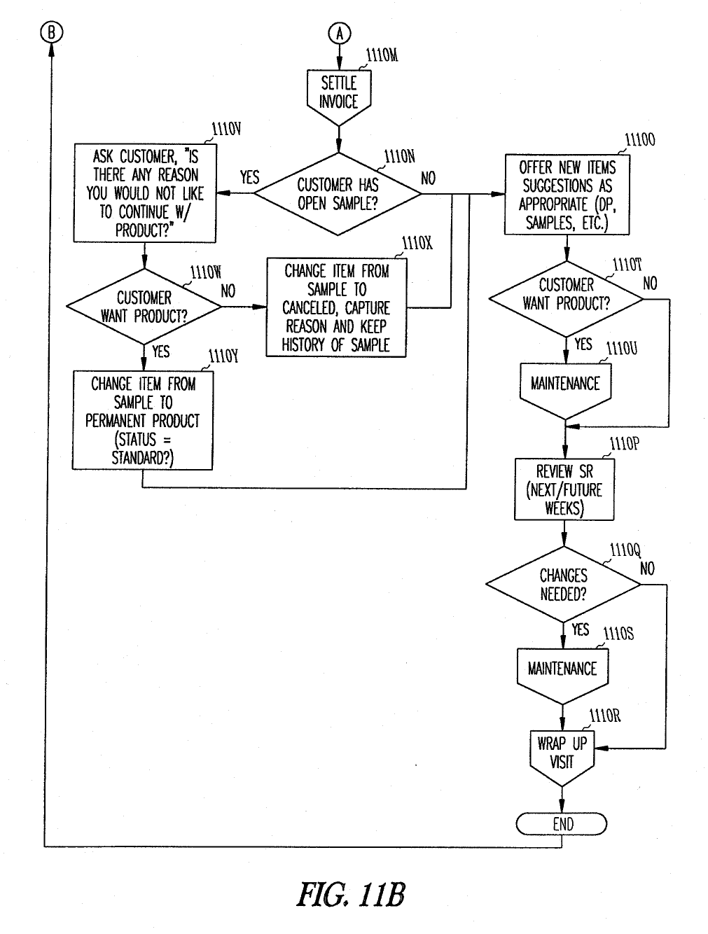

Referring now to FIGS. 11A and 11B, there is illustrated an example embodiment 1100 of a process for an RSR to wrap up a visit to a supplied entity 135, according to still another example embodiment, using the review route function. The RSR 150 previews the SR on HH, and modifies if needed 1110A. The RSR then returns to the customer location and approaches a key contact 1110B. If the contact is present 1110C, the RSR 150 reviews the SR for the current week with the key contact 1110D. If no changes are needed 1110E, an invoice is generated 1110F. If the customer doesn't approve 1110G, the invoice is adjusted 1110H, and the system returns to the review of the SR 1110D. If changes are needed at 1110E, then maintenance is done 1110I, and the system returns to the SR review 1110D. If the contact is not present 1110C, and the signature is one file 11101, then the visit is wrapped up 1110L. If the signature is not on file 110K, then the RSR 150 gets a signature from someone else on site as possible 1110K, and the process is wrapped up 1110L.

If the customer approves the invoice 1110G, the invoice is settled 1110M. Next, if the customer has no open samples 1110N, then the customer is offered new items or suggestions as appropriate (DP, samples, etc.) 1100. If the customer does not want the products offered 1110T, the RSR 150 reviews the SR for the next week or future weeks 1110P, and if any changes are needed 1110Q, maintenance 1110S is performed, and the visit is wrapped up 1110R, and if no changes are needed 1110Q, the visit is also wrapped up 1110R. If the customer does want product 1110T, then the system is updated with maintenance 1110U, and the review of SR and the rest of the process proceeds as described above. If the customer has an open sample 1110N, the RSR 150 asks the customer, “is there any reason you would not like to continue w/product? ” 1110V, and if the customer wants the product 1110W, the item is changed from sample to cancelled, the RSR 150 changes the item from sample to permanent product 1110Y. If the customer does not want the product 1110W, the item is changed from sample to cancelled, and the reason is recorded to keep a history of the sample 1110X.

Thus, according to one example embodiment, the system 100 automates the processes 500 and implements a number of the processes performed in the field using the portable handheld unit 200. The system 100 may be centered on the RSR's 150 process of servicing the serviced entities 135 to create an efficient, electronic method of completing the routine tasks of delivery, orders, changes, and invoicing. The system 100 may also systematizes important communication steps that help to build the relationship between the RSR 150 and the serviced entity 135.

According to still another example embodiment, system 100 may include global positioning system (GPS) capability, such that, for example, the handheld unit 170C may include a GPS device capable determining the location of the hand held unit 170C from satellite GPS signals. This location information may then be used to assist the device 170C and the user in determining their location, or determining a route to a desired destination, as is conventionally found in state of the art GPS navigational and locator systems. The unit 170C may then record its position along a route, and that information used by other systems for the purpose of improving the delivery process, or for other purposes.

Thus, in the preceding detailed description and accompanying drawings, specific embodiments have been disclosed in which the inventive subject matter can be practiced. It is understood that other embodiments may be utilized and structural changes may be made without departing from the scope of the inventive subject matter.

1. A system comprising:
a computing system including at least one computer and at least one data storage unit;
at least one database of information stored on the computing system;
a hand-held device in communication with the computing system;
a preview route program operable on the computing system to use at least in part the database of information to
a) generate a summary of orders, returns and sampling activity for a future route service event for a supplied entity,
b) generate a summary of unusual charges for the future route service event, and
c) generate a report of bulk item counts that are out of the ordinary based on at least in part historical activity for the supplied entity;
a service route program operable on the computing system to use at least in part the database of information to
a) generate instructions for execution of a service even for the supplied entity,
b) generate instructions to build a load for a supplied entity site; add/change products and orders with the appropriate pricing based on one or more pricing policies applicable to the supplied entity,
c) process returns that are due and generate appropriate credits and charges when invoicing,
d) view/edit supplied entity information such as preferences, contact information, and status;
settle supplied entity software operable on the computing system to use at least in part the database of information to
a) present a summary of at least one activity for the supplied entity account wherein the activity is selected from the group: a review of orders, returns, other changes, service calls and sampling activity,
b) generate invoicing information based on any changes made to the account, wherein the invoicing information includes line items that can be viewed and adjusted,
c) capture a supplied entity signature in all or some circumstances; and
check-in/approve route software operable on the computing system to use at least in part the database of information to
provide visibility of changes on the route to management personnel for the route service representative, including visibility of one or more items selected from the group of: visibility to all invoice adjustments to ensure proper business controls, visibility to all route maintenance to ensure proper business controls, or visibility to all sampling activity.

2. A system according to claim 1 further wherein the system includes a bar code reader or a RFID tag reader.

3. A system according to claim 2 further including automated scanning software to obtain information about a scanned item from the information stored in the system.

4. A system comprising:
a computing system including at least one computer and at least one data storage unit;
at least one database of information stored on the computing system;
a hand-held device in communication with the computing system;
value-on-site reporting software operable through the hand-held device of the computing system during a service call to a supplied entity, wherein the software is operable to use at least in part the database of information to present a summary of activities for the supplied entity, wherein the supplied entity is serviced by a supplying entity, and further wherein the activities represent value generated for the supplied entity, and wherein the value generating activities include at least one activity that the supplied entity is not being charged for by the supplying entity.

5. A system according to claim 4 further wherein the value generating activities include activities that the supplied entity is being charged for by the supplying entity.

6. A system according to claim 4 further wherein the value generating activities are selected from the group: a review of orders, returns, other changes, service calls and sampling activity.

7. A system according to claim 4 further including invoicing software operable on the computing system to generate invoicing information for the activities on the account that are being billed for during the service call to the account, wherein the invoicing information includes line items that can be viewed and adjusted.

8. A system according to claim 4 further including signature capture software operable on the computing system to capture a supplied entity signature.

9. A system according to claim 4 further wherein the system includes a bar code reader or a RFID tag reader.

10. A system according to claim 4 further including automated scanning software to obtain information about a scanned item from the information stored in the system.

11. An process comprising:
storing industrial supplies in a first originating facility operated by a supplying entity;
transporting industrial supplies from the first originating facility to one or more supplied facilities;
delivering the industrial supplies to at least one of the supplied facilities;
while delivering the industrial supplies using a hand-held computing device to generate a summary of activities performed by the supplying entity for the supplied facility, the value generating activities include at least one activity that the supplied facility is not being charged for by the supplying entity.

12. A process according to claim 11 further wherein the value generating activities include activities that the supplied facility is being charged for by the supplying entity.

13. A process according to claim 11 further wherein the value generating activities are selected from the group: a review of orders, returns, other changes, service calls and sampling activity.

14. A process according to claim 11 further including using the hand-held device to generate invoicing information for the activities on the account that are being billed for during the service call to the account, wherein the invoicing information includes line items that can be viewed and adjusted.

15. A process according to claim 11 further including using the hand-held device to capture a signature of at least one person acting as an agent for the supplied facility.

16. A process according to claim 11 further including using a bar code reader or a RFID tag reader on the hand-held device.

17. A process according to claim 11 further obtaining information about a scanned item from the database of information.
